(19) United States
(12) Patent Application Publication
(10) Pub. No.: US 2002/0195476 A1
(43) Pub. Date: Dec. 26, 2002

(54) Head assembly of a disk apparatus having a head IC chip mounted on a suspension by ultrasonic bonding

(75) Inventors: Shunji Baba, Kawasaki-shi (JP); Hidehiko Kira, Kawasaki-shi (JP); Norio Kainuma, Kawasaki-shi (JP); Toru Okada, Kawasaki-shi (JP)

Correspondence Address: Patrick G. Burns, Suite 2500, 300 South Wacker Drive, Chicago, IL, 60606, US

(73) Assignee: Fujitsu Limited, Kawasaki-shi (JP)

(21) Appl. No.: 10/185,801

(22) Filed: Jun. 27, 2002

Related U.S. Application Data
(62) Division of application No. 09/543,244, filed on Apr. 5, 2000, now abandoned.

(30) Foreign Application Priority Data
Jul. 2, 1999 (JP) 11-189281
Oct. 25, 1999 (JP) 11-303062

(51) Int. Cl. B23K 20/12

(52) U.S. Cl. 228/2.1; 228/110.1

(57) ABSTRACT

A suspension of a head assembly provided in a disk apparatus is prevented from being deformed due to mounting of a head IC chip onto the suspension. The head IC chip mounted on the suspension has protruding electrodes made of gold. The suspension has electrode pads connected to the respective protruding electrodes of the head IC chip. Each of the electrode pads has a surface layer made of gold. The protruding electrodes of the head IC chip are bonded to the electrode pads of the suspension by ultrasonic bonding.

### BACKGROUND OF THE INVENTION

1. Field of the Invention

The present invention generally relates to a head assembly of a disk apparatus and, more particularly, to a head assembly having a semiconductor chip bonded to a suspension by ultrasonic bonding.

2. Description of the Related Art

Generally, a hard disk apparatus has a magnetic head assembly mounted to a pivotable arm driven by an actuator. The magnetic head assembly comprises a head slider and a head IC chip which are mounted on a suspension. The magnetic head assembly is positioned to face a hard disk so as to read information recorded on the hard disk or write information on the hard disk. The head slider has a magnetic head that is normally formed according to a thin-film technology.

The magnetic head comprises an inductive head and a magnetoresistive head. The inductive head writes information on the hard disk. The magnetoresistive head reads information recorded on the hard disk. The head IC chip controls operations of the magnetic head assembly and amplifies low-level signals output from the magnetoresistive head.

The suspension is normally formed of a stainless steel plate having a small thickness of about 25 μm. Accordingly, the suspension is easily bent or twisted. If the suspension is bent or twisted, the magnetic head supported by the suspension is displaced from a normal position with respect to the disk, which may result in a reading error or writing error of the magnetic head assembly. Thus, the head IC chip must be mounted on the suspension so that the mounting of the head IC chip does not cause a deformation of the suspension arm.

FIG.1A is a perspective view of a conventional magnetic head assembly 10. The magnetic head assembly 10 comprises: a suspension 11; a gimbal plate 12 mounted on an extreme end of the suspension 11; a head slider 20 supported by the gimbal plate 12; and a head IC chip 30 mounted on a head IC chip mounting portion 15 provided in the middle of the suspension 11. The head IC chip 30 is mounted on the suspension 11 so that the circuit forming surface 30a of the head IC chip 30 faces the head IC chip mounting portion 15.

As shown in FIG. 1B, the suspension 11 is formed of a thin stainless steal plate 13, and a plurality of copper wiring patterns 14 are formed thereon. The head IC chip mounting portion 15 of the suspension 11 is provided with a plurality of electrodes 16. The electrodes 16 are also made of copper, and, therefore, the surface of each of the electrodes 16 is copper.

The head IC chip 30 has a plurality of electrodes 31, each of which is provided with a solder bump 32. The head IC chip 30 is mounted on the suspension 11 according to a mounting operation shown in FIG. 2. That is, the head IC chip 30 is mounted onto the suspension 11 by performing a mounting operation comprising the steps of: applying a flux onto the electrodes 16 of the suspension 11; placing the head IC chip 30 in the facedown position so that the solder bumps 32 contact respective electrodes 16; and heating the solder bumps 32 and the electrodes 16 by having passed through a reflow furnace to heat at 260° C. for a few tens of seconds so as to melt the solder bumps 32. After the head IC chip 30 is mounted on the suspension 11, the head IC chip 30 and the suspension 11 are cleaned, and finally an under-fill 33 is supplied to a space formed between the head IC chip 30 and the suspension 11.

Accordingly, as shown in FIG. 1B, the IC head chip 30 is electrically connected to the electrodes 16 of the suspension 11, and securely fixed to the suspension 11 by the under-fill 33. The under-fill 33 also serves to protect an integrated circuit formed on the surface 30a of the head IC chip 30.

After the suspension 11 exits the reflow furnace together with the head IC chip 30, the melted solder bumps 32 immediately solidify, and the electrodes 31 of the head IC chip 30 are electrically connected to the respective electrodes 16 of the suspension 11 via the solder bumps 32. In this state, the suspension 11 and the head IC chip 30 are cooled down from about 200° C. to a room temperature. Accordingly, the suspension 11 deforms due to the difference in thermal expansion between the suspension 11 and the head IC chip 30. If a magnitude of deformation of the suspension 11 exceeds an allowable limit, a designated positional relationship between the magnetic head and the hard disk is changed to the extent exceeding an allowable range, which condition may cause a reading error or writing error of the magnetic head.

The above-mentioned method of bonding the head IC chip 30 to the suspension 11 is well known in the semiconductor manufacturing field. The method is referred to as flip-chip bonding.

In the flip-chip bonding, a plurality of bumps provided on a semiconductor chip (such as the head IC chip 30) are simultaneously bonded to a plurality of pads formed on a substrate (such as the head IC chip mounting portion 15 of the suspension11). Generally, solder bumps are bonded by being subjected to a reflow process as mentioned above. However, if bumps are made of gold (Au bump), the reflow process cannot be applied. The bumps made of gold can be bonded by an ultrasonic bonding method as suggested in Japanese Laid-Open Patent Application NO. 59-208844.

The ultrasonic bonding method has been used for manufacturing a semiconductor device in which wires such as gold (Au) wires are used to electrically connect electrodes of a semiconductor chip to electrode pads formed on a wiring board or substrate. The wire bonding is normally performed by an automatic wire bonding apparatus. In the automatic wire bonding apparatus, a wiring board on which a semiconductor chip is mounted is heated, and an Au ball Is formed on an end of an Au wire extended from a capillary by an electric discharge generated by an electric torch. The Au ball is brought into contact with a pad of the semiconductor chip with a predetermined pressure while vibrating the capillary by an ultrasonic wave in a direction parallel to the pad.

Japanese Laid-Open Patent Application No. 2-58844 discloses an ultrasonic generator used for an ultrasonic wire bonding apparatus. The ultrasonic generator monitors an output waveform of the ultrasonic wave during a bonding process so as to perform a feedback control in the ultrasonic wave generating operation. The feedback control is performed to achieve an optimum bonding condition by eliminating undesired influences of a surface condition of the semiconductor chip to be bonded and other external disturbances which may occur during the bonding process.

The ultrasonic generator disclosed in the above-mentioned patent document drives an ultrasonic wave oscillating element (a piezoelectric transducer) by an ultrasonic wave oscillating circuit and an output power and time setting circuit. The ultrasonic generator also includes: an A/D converter circuit which samples an output waveform of the ultrasonic wave while a bonding process is being performed; an optimum waveform setting circuit which sets an optimum output waveform for bonding; and a comparator circuit which compares the sampled output waveform with the optimum waveform. Accordingly, a differential signal waveform is output from the comparator circuit, and the differential signal waveform is fed back to the output power and time setting circuit.

The above-mentioned Japanese Laid-Open Patent Application No. 2-58844 suggests that the detection of an actual output waveform during a bonding process be made by a piezoelectric element mounted to an ultrasonic wave pickup. However, the patent document does not disclose the specific structure of the detection of such an output waveform. That is, the patent document does not disclose a specific structure of a mechanism for detecting the output waveform of the ultrasonic wave oscillating element by pressing the ultrasonic wave pickup against the bonding portion. If a wedge bonding method is used, it is considered that a mechanism for detecting an output waveform of the ultrasonic wave oscillating element by fixing an ultrasonic wave pickup to the wedge which applies a pressing force to a wire is needed. Additionally, in a case of the above-mentioned automatic bonding apparatus, a mechanism for detecting the output waveform of the ultrasonic wave oscillating element by attaching an ultrasonic wave pickup to the capillary is needed.

On the other hand, there is a wireless bonding method such as the above-mentioned flip-chip bonding. If a semiconductor chip has Au bumps, a reflow process cannot be applied due to limitations in the thermal condition. Thus, an ultrasonic bonding method may be used to bond such a semiconductor chip having Au bumps. However, a technique to control the bonding conditions such as that in the above-mentioned ultrasonic wire bonding method has not been established for the flip-chip bonding thus far.

Accordingly, if the ultrasonic flip-chip bonding operation is continuously performed for a long time in the same condition without monitoring the ultrasonic waveform, insufficient bonding may occur due to an improper condition established during the bonding operation. For example, if slippage occurs between the ultrasonic wave oscillating element and the semiconductor chip, a sufficient ultrasonic wave cannot be transmitted to the bonding area. In such a case, the ultrasonic bonding operation may be stopped before a complete bonding is achieved, which results in a defective semiconductor device. On the other hand, if the ultrasonic bonding operation continues for an excess time for some reasons after a complete bonding is achieved, a stress is generated in the bonded portion due to the unnecessary ultrasonic wave applied during the excess time, which may result in a defect occurring in the bonded portion.

### SUMMARY OF THE INVENTION

It is a general object of the present invention to provide an improved and useful head assembly of a disk apparatus in which the above-mentioned problems are eliminate.

A more specific object of the present invention is to provide a head assembly having a suspension which is prevented from being deformed due to mounting of a head IC chip onto the suspension.

Another object of the present invention is to provide an ultrasonic bonding method and apparatus for bonding a semiconductor chip by monitoring an actual condition of ultrasonic bonding so as to perform a feedback control in the ultrasonic bonding to establish an optimum bonding condition.

In order to achieve the above-mentioned objects, there is provided according to one aspect of the present invention a head assembly of a disk apparatus, comprising: a head IC chip having a plurality of protruding electrodes made of gold; and a suspension supporting the head IC chip, the suspension having a plurality of electrodes connected to the respective protruding electrodes of the head IC chip, each of the electrodes having a surface layer made of gold, wherein the protruding electrodes of the head IC chip are bonded to the electrodes of the suspension by ultrasonic bonding.

According to the present invention, since the protruding electrodes are made of gold and the surface layer of the electrode pads are also made of gold, the protruding electrodes can be bonded to the electrode pads by ultrasonic bonding. Accordingly, there is no need to raise the temperature of the suspension to a temperature of a solder reflow process. Thus, the suspension is prevented from being deformed due to a thermal stress.

Additionally, there is provided another aspect of the present invention a disk apparatus comprising: a disk for storing information; an arm movable relative to the disk; an actuator driving the arm; and a head assembly mounted to the arm, the head assembly comprising: a head IC chip having a plurality of protruding electrodes made of gold; and a suspension supporting the head IC chip, the suspension having a plurality of electrodes connected to the respective protruding electrodes of the head IC chip, each of the electrodes having a surface layer made of gold, wherein the protruding electrodes of the head IC chip are bonded to the electrodes of the suspension by ultrasonic bonding.

According to the above-mentioned invention, since the suspension is prevented from being deformed due to a thermal stress when the head IC chip is bonded to the suspension, a positional relationship between the head assembly and the disk does not change. Thus, an accurate reading and writing operation by the head can be maintained in the disk apparatus.

Additionally, there is provided according to another aspect of the present invention an ultrasonic bonding method for bonding a semiconductor chip having a plurality of protruding bumps to a wiring board having a plurality of electrode pads, the ultrasonic bonding method comprising the steps of: bonding the protruding electrodes of the semiconductor chip to the electrode pads of the wiring board by applying an ultrasonic vibration to one of the semiconductor chip and the wiring board; detecting an actual waveform of the ultrasonic vibration of the one of the semiconductor chip and the wiring board; and controlling the bonding process based on the actual waveform of the ultrasonic vibration of the one of the semiconductor chip and the wiring board.

Additionally, there is provided according another aspect of the present invention an ultrasonic bonding apparatus for bonding a semiconductor chip having a plurality of protruding electrodes to a wiring board having a plurality of electrode pads, the ultrasonic bonding apparatus comprising: an ultrasonic vibration generating mechanism generating an ultrasonic vibration by an ultrasonic wave oscillating element, the ultrasonic vibration being transmitted to one of the semiconductor chip and the wiring board so as to bond the protruding electrodes of the semiconductor chip to the electrode pads of the wiring board; and a sensor detecting an actual waveform of the ultrasonic vibration of the one of the semiconductor chip and the wiring board so as to control the ultrasonic vibration generated by the ultrasonic vibration generating mechanism based on the actual waveform detected by the sensor.

According to the above-mentioned ultrasonic bonding method and apparatus, the waveform of the ultrasonic vibration of the semiconductor chip or the wiring board is detected and monitored by the sensor. That is, for example, a difference in the waveform of the ultrasonic vibration between the semiconductor devices produced by the ultrasonic bonding apparatus is investigated, or the waveform of the ultrasonic vibration of each semiconductor chip is compared with a predetermined reference waveform so as to recognize the condition of ultrasonic bonding being performed and take a necessary operation to optimize the bonding condition. Thus, a high quality semiconductor device can be produced by the flip chip bonding method and apparatus.

Other object, features and advantages of the present invention will become more apparent from the following detailed description when read in conjunction with the accompanying drawings.

### BRIEF DESCRIPTION OF THE DRAWINGS

FIG. 1A is a perspective view of a conventional magnetic head assembly; FIG. 1B is a cross-sectional view of a part of the magnetic head assembly shown in FIG. 1;

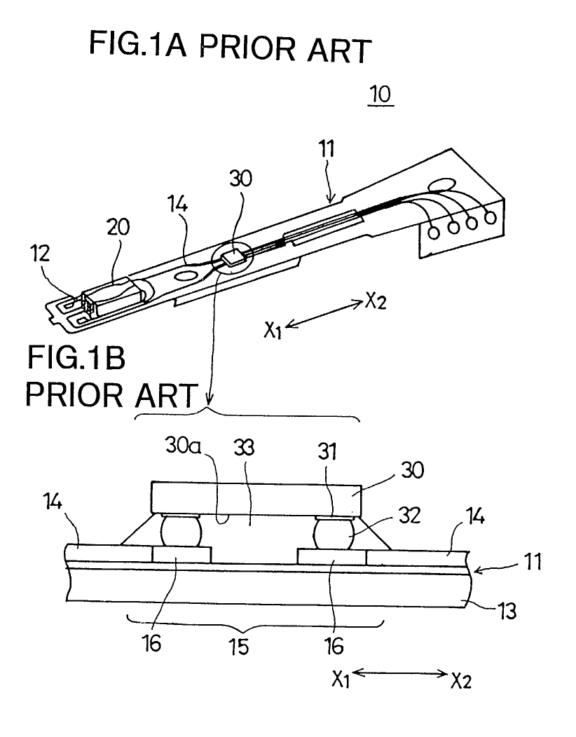

FIG. 2 is a flowchart of a conventional process of mounting a head IC chip onto a suspension;

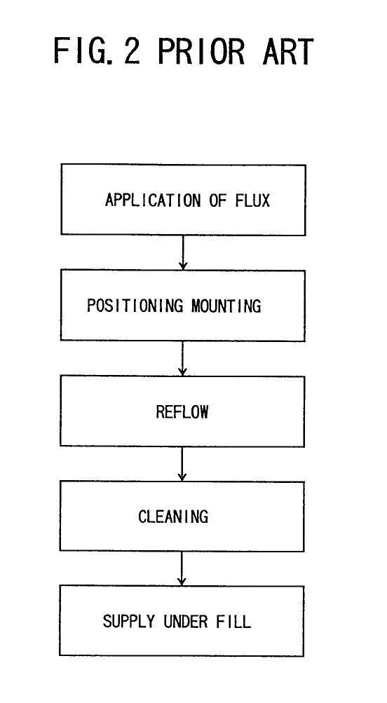

FIG. 3A is a perspective view of a magnetic head assembly according to a first embodiment of the present invention; FIG.3B is an enlarged cross-sectional view of a head IC chip mounting portion of a suspension shown in FIG. 3A; FIG. 3C is a cross-sectional view of the suspension shown in FIG. 3A; FIG. 3D is an enlarged perspective view of an end portion of a slider shown in FIG. 3A;

FIG. 4A is a cross-sectional view of the head IC chip mounting portion before the head IC chip is mounted; FIG. 4B is a cross-sectional view of the head IC chip mounting portion onto which the hear IC chip is being mounted;

FIG. 5 is an illustration for explaining formation of an Au bump;

FIG. 6 is a flowchart of a mounting operation of the head IC chip to the head IC chip mounting portion of the suspension;

FIG. 7A is a perspective view of a hard disk apparatus provided with the magnetic head assemblies shown in FIG. 3A; FIG. 7B is an enlarged side view of the magnetic head assemblies provided in the hard disk apparatus shown in FIG. 7A;

FIG. 8 is an illustration of a structure of a flip chip bonding apparatus according to a second embodiment of the present invention;

FIG. 9 is an illustration of a structure of a flip chip bonding apparatus according to a third embodiment of the present invention;

FIG. 10 is an illustration of a structure of a flip chip bonding apparatus according to a fourth embodiment of the present invention;

FIG. 11 is an illustration of a structure of a flip chip bonding apparatus according to a fifth embodiment of the present invention;

FIG. 12 is a flowchart of an ultrasonic bonding process performed by the flip chip bonding apparatus shown in FIG. 11;

FIG. 13 is an illustration of a structure of a flip chip bonding apparatus according to a sixth embodiment of the present invention; and

FIGS. 14A, 14B and 14C are illustrations for explaining waveforms of an ultrasonic vibration during an ultrasonic bonding process.

### DETAILED DESCRIPTION OF THE PREFERRED EMBODIMENTS

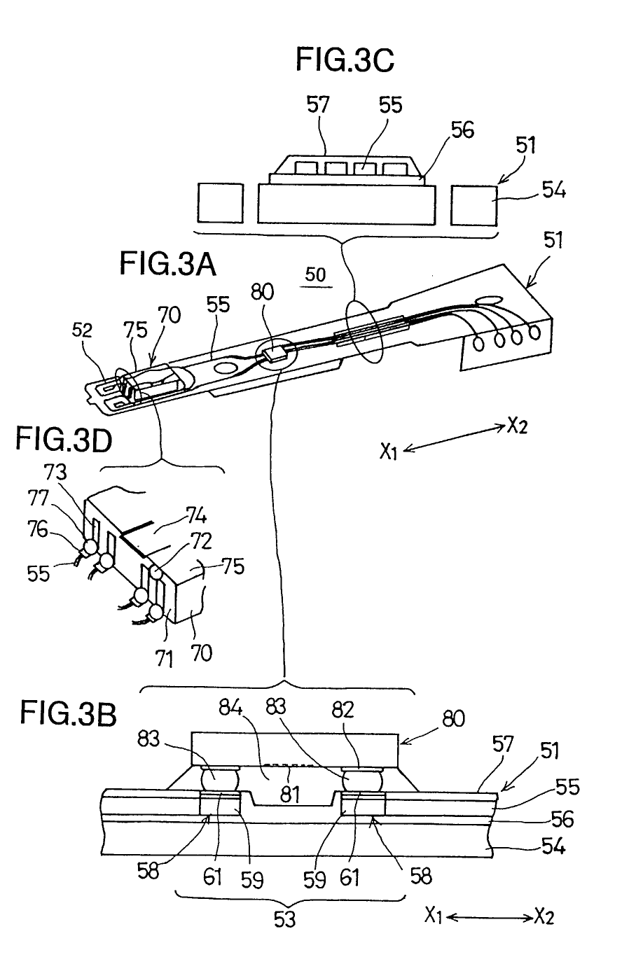

A description will now be given of a magnetic head assembly according to a first embodiment of the present invention. FIG. 3A is a perspective view of a magnetic head assembly 50 according to the first embodiment of the present invention.

The magnetic head assembly 50 comprises: a suspension 51; a gimbal plate 52 mounted on an end of the suspension 51; a head slider 70 mounted on the gimbal plate 52; and a head IC chip 80 mounted on a the suspension 51.

As shown in FIG. 3B, the suspension 51 is made of a thin stainless steel plate 54 having a thickness of 25 μm. The stainless steel plate 54 is covered by a polyimide film 56 as an insulating layer. A plurality of copper wiring patterns 55 are formed on the ployimide film 56. The wiring patterns 55 are covered and protected by another polyimide film 57 as an insulating layer.

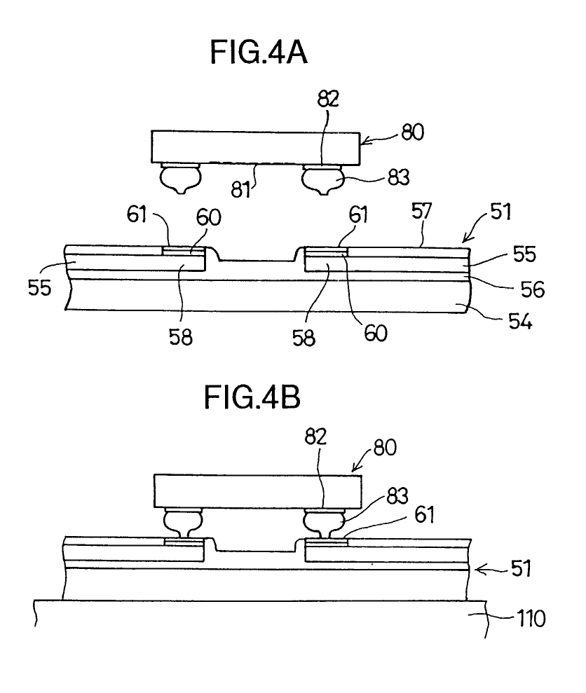

A head IC chip mounting portion 53 is formed in the middle of the suspension 51 so that the head IC chip 80 is bonded thereto. In the head IC chip mounting portion 53, an electrode 58 is provided an end of each of the wiring patterns 55. The electrode 58 comprises, as shown in FIG. 4A, a nickel (Ni) layer 60 and a gold (Au) layer 61 provided on the nickel layer 60. Accordingly, the gold layer 61 is exposed in the electrode 58. The nickel layer 60 and the gold layer 61 can be formed by various methods such as a sputtering method or a plating method.

The head IC chip 80 has a circuit forming surface on which an integrated circuit 81 is formed. A plurality of electrodes 82 are formed on the circuit forming surface of the head IC chip 80. The electrodes 82 are made of aluminum. Protruding electrode such bumps 83 are formed on the electrodes 82. The bumps 83 are made of gold (Au).

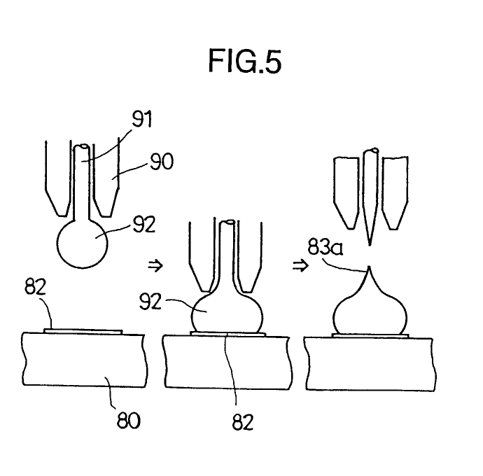

FIG. 5 is an illustration for explaining a manufacturing process of the Au bumps 83. The Au bumps 83 are formed by using a wire bonder. That is, an Au wire 91 is extended from a capillary 90 of the wire bonder, and an Au ball 92 is formed at the end of the Au wire 91. Then, the capillary 90 is moved downward so as to contact the Au ball 92 to the electrode 82 of the head IC chip 80. The Au ball is melted by an ultrasonic wave applied thereto so as to bond the Au ball 92 to the electrode 82. Then, a portion of the Au wire 91 extending from the capillary 90 is clamped by a wire damper (not shown in the figure), and the capillary 90 is moved upward so as to cut the Au wire 91.

As shown in FIG. 3B, the head IC chip 80 is mounted onto the suspension 51 in a position in which the circuit forming surface facing downward. That is, the Au bumps 83 of the head IC chip 80 are bonded to the Au layer 61 of the electrode 58 by an ultrasonic bonding method. Accordingly, the head IC chip 80 is mounted onto the suspension 51 by Au—Au bonding.

Additionally, the head IC chip 80 is fixed to the suspension 51 by an under-fill 84 supplied to a space between the head IC chip 80 and the suspension 51 so as to secure the bonding of the Au bumps 83 to the electrodes 58. The under-fill 84 has a function to protect the integrated circuit formed on the circuit forming surface of the head IC chip 80.

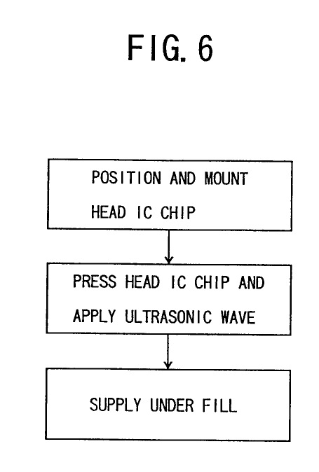

As shown in FIG. 4B and FIG. 6, the head IC chip 80 is mounted onto the suspension 51 by using an ultrasonic bonding method. FIG. 6 is a flowchart of the mounting operation of the head IC chip 80 to the suspension 51. First, the suspension 51 is placed on a table 110, and the head IC chip 80 is positioned above the suspension 51 so that the Au bumps 83 of the head IC chip 80 contact the respective electrodes 58 of the suspension 51 as shown in FIG. 4A. Then, the head IC chip 80 is pressed onto the suspension 51 by a head unit 95 of an ultrasonic bonder and at the same time an ultrasonic wave is applied to the head IC chip 80 by the head unit 95 for a few seconds. Accordingly, each of the Au bumps 83 vibrates due to the ultrasonic wave and is bonded to the Au layer 61 of the respective one of the electrodes 58. Thereafter, the under-fill 84 such as epoxy resin is supplied to the space between the head IC chip 80 and the suspension 51, and is cured by heating.

It should be noted that since the above-mentioned bonding process is performed at a room temperature, no thermal stress is generated in the suspension 51. Thus, the suspension 51 does not deform during or after the bonding operation.

As shown in FIG. 3D, the head slider 70 has a side surface 71 on which a magnetic head 72, a wiring pattern (not shown in the figure) and four electrodes 73 are formed. The head slider 70 has a top surface 74 on which a rail 74 is formed. The magnetic head 72 is formed by using a thin-film technology. The magnetic head 72 includes an inductive head and a magnetoresistive head. The slider 70 is attached to the gimbal plate 52 by an adhesive. Each of the electrodes 73 is connected to the respective electrode 76 by an Au ball 77 which is bonded by a thermal pressing method.

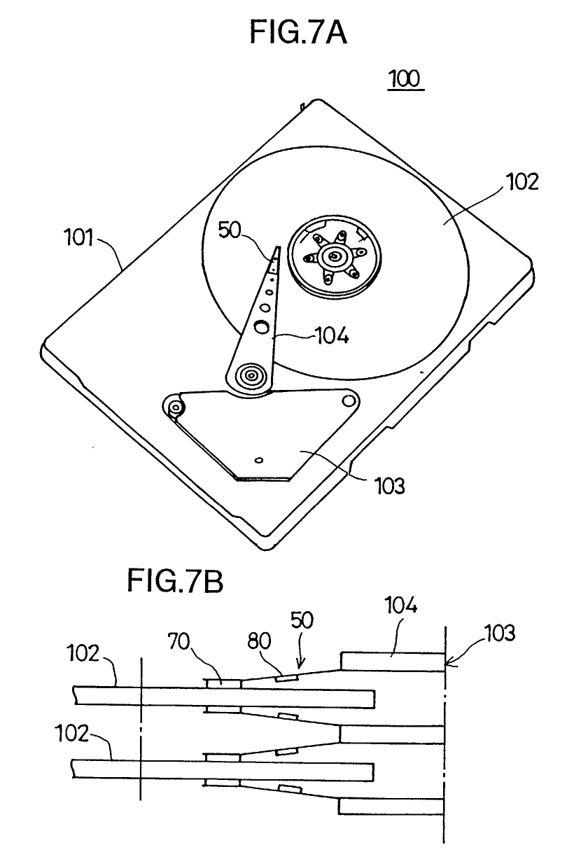

The head assembly having the above-mentioned structure is incorporated in a hard disk apparatus 100 shown in FIG. 7A.

The hard disk apparatus 100 comprises a housing 101, tow hard disks 102 rotatable within the housing 101, an actuator 103 which drives an arm 104 and four head assemblies 50 connected to the arm 104. As shown in FIG. 7B, a base end of each of the magnetic head assemblies 50 is fixed to the arm 104. When a reading or writing operation is performed, the hard disks 102 are rotated, and the magnetic head assemblies 50 are moved in a radial direction of the hard disks 102 so as to access a desired track on the hard disks 102. The movement of the magnetic head assemblies 50 is achieved by the arm 104 driven by the actuator 103.

A description will now be given of an ultrasonic bonding method and apparatus according to a second embodiment of the present invention.

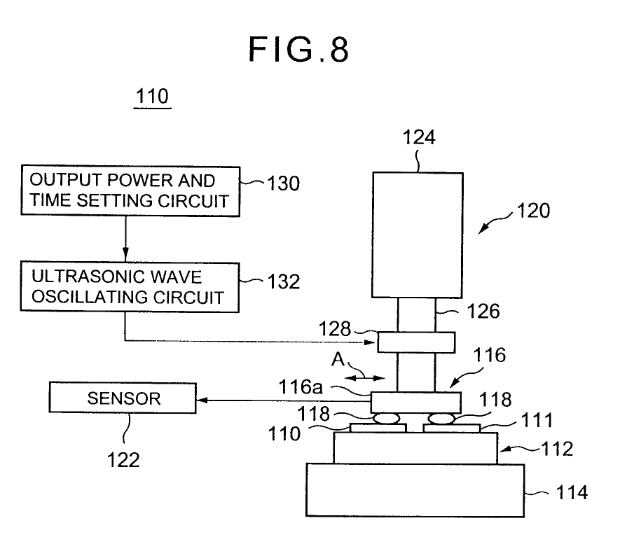

FIG. 8 is an illustration of a structure of a flip chip bonding apparatus 110 according to the second embodiment of the present invention.

The flip chip bonding apparatus 110 according to the second embodiment of the present invention comprises: a stage 114 on which a wiring board 112 is placed; a bonding unit 120; a control unit (not shown in the figure) which controls operations of the bonding unit 120; and a sensor 122 which detects a vibration of a semiconductor chip 116 to be mounted onto the wiring board 122. The wiring board 112 has a plurality of electrode pads 111, and the wiring board 112 is placed on the table 114 so that the surface on which the electrode pads 111 are formed faces upward. The semiconductor chip 116 has a plurality of bumps 118 on a circuit forming surface thereof. The semiconductor chip 116 is supported by the bonding unit 20 so that the circuit forming surface on which the bumps are formed faces downward. The semiconductor chip 116 supported by the bonding unit 120 is brought into contact with the wiring board 112 on the table 114 for bonding.

The bonding unit 120 comprises a bonding head 124, a bonding tool 126 extending downward from the bonding head 124 and an ultrasonic wave oscillating element (piezoelectric transducer) 128 which is integral with the bonding tool 126. The bonding unit 120 also comprises a conveyor mechanism (not shown in the figure) to suction and convey the semiconductor chip 116. The bonding unit 120 further comprises a pressing mechanism (not shown in the figure) to move the bonding tool 126 downward so as to render the semiconductor chip 116 to contact the wiring board 112 and presses the semiconductor chip 116 against the wiring board 112 with a predetermined pressure force.

The control unit for controlling the bonding unit 120 includes an output power and time setting circuit 130 and an ultrasonic wave oscillating circuit 132. The output power and time setting circuit 130 and the ultrasonic wave oscillating circuit 132 generates an ultrasonic signal and supplies the ultrasonic signal to the ultrasonic wave oscillating element 128. Accordingly, an ultrasonic wave oscillating mechanism is constituted by the output power and time setting circuit 130, the ultrasonic wave oscillating circuit 132 and the ultrasonic wave oscillating element 128.

The sensor 22 in this embodiment is a laser Doppler vibration meter which is a non-contact type vibration meter. Accordingly, the sensor 22 receives a light beam reflected by a side surface 116a of the semiconductor chip 116 so as to detect a change in the frequency of the reflected light beam caused by the Doppler effect.

A description will now be given of a bonding method performed by the above-mentioned flip chip bonding apparatus 110 shown in FIG. 8.

First, a predetermined output power of an ultrasonic wave and a time for oscillating the ultrasonic wave are input to the output power and time setting circuit 130 by using an input arrangement (not shown in the figure). Then, the wiring board 112 is placed on the stage 114, and the semiconductor chip 116 is conveyed to a predetermined position by the bonding unit 120 so that the bumps 118 of the semiconductor chip 116 contact the respective electrode pads 111 of the wiring board 112. The bonding tool 126 is further moved downward so as to press the semiconductor chip 116 against the wiring board 112 with a predetermined pressing force. Then, the output power and time setting circuit 130 and the ultrasonic wave oscillating circuit 132 are operated so as to vibrate the ultrasonic wave oscillating element 128. Accordingly, the ultrasonic wave generated by the ultrasonic wave oscillating element 128 is transmitted to the semiconductor chip 116, and the semiconductor element 116 vibrates in a horizontal direction (indicated by an arrow A in the figure). Thus, the bumps 118 and the electrode pads 111 are bonded to each other by the ultrasonic vibration.

In the process of bonding by the ultrasonic wave generated by the ultrasonic wave oscillating element 128, the waveform of the vibration of the semiconductor chip 116 is detected and monitored by the sensor 122. That is, for example, a difference in the waveform of the vibration between the semiconductor devices produced by the flip chip bonding apparatus 110 is investigated, or the waveform of the vibration of each semiconductor chip is compared with a predetermined reference waveform so as to recognize the condition of ultrasonic bonding being performed and take a necessary operation to optimize the bonding condition. Thus, a high quality semiconductor device can be produced by the flip chip bonding apparatus 110.

A description will now be given of an ultrasonic bonding method and apparatus according to a third embodiment of the present invention.

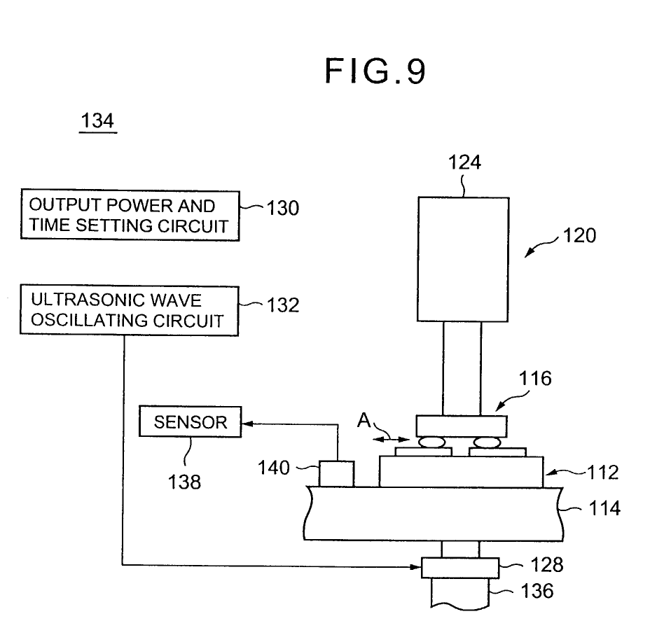

FIG. 9 is an illustration of a structure of a flip chip bonding apparatus 134 according to the third embodiment of the present invention. In FIG. 9, parts that are the same as the parts shown in FIG. 8 are given the same reference numerals, and descriptions thereof will be omitted.

The flip chip bonding apparatus 134 according to the present embodiment has the same structure as the flip chip bonding apparatus 110 shown in FIG. 8 except for the ultrasonic wave oscillating element being provided underneath the stage 114. That is, the ultrasonic wave oscillating element 128 is integrated with a support member 136 which is supported on a base (not shown in the figure). The ultrasonic wave oscillating element 128 generates an ultrasonic vibration, and the ultrasonic vibration is transmitted to the wiring board 112 via the table 114. The wiring board 112 vibrates in a direction indicated by an arrow A in the figure.

The sensor 122 of the flip chip bonding apparatus 110 is replaced by a sensor 138, which is a contact type vibration meter. That is, the sensor 138 includes a piezoelectric element 140 so as to detect a change in a current generated by the piezoelectric element 140.

According to the ultrasonic bonding method performed by the flip chip bonding apparatus 134 shown in FIG. 9, the waveform of a vibration of the wiring board 112 is detected and monitored by the sensor 138, and the condition of bonding is controlled as in the same manner as the above-mentioned second embodiment.

A description will now be given of an ultrasonic bonding method and apparatus according to a fourth embodiment of the present invention.

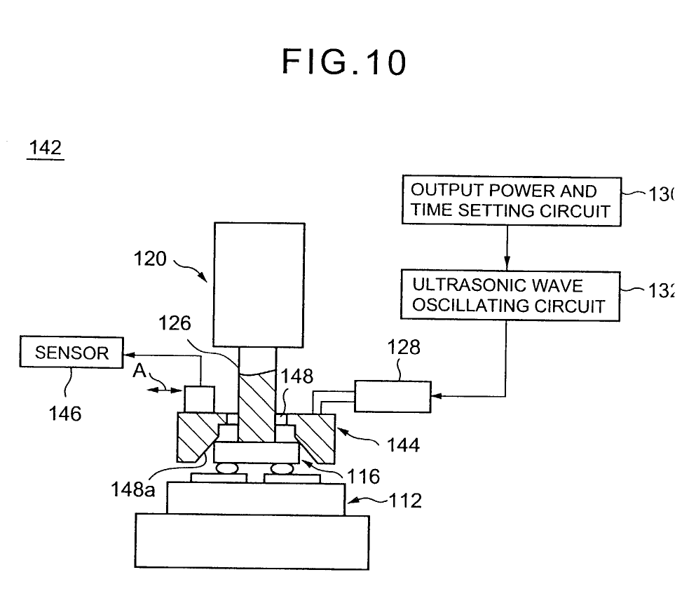

FIG. 10 is an illustration of a structure of a flip chip bonding apparatus 142 according to the fourth embodiment of the present invention. In FIG. 10, parts that are the same as the parts shown in FIG. 8 are given the same reference numerals, and descriptions thereof will be omitted.

The flip chip bonding apparatus 142 according to the present embodiment has the same structure as the flip chip bonding apparatus 110 shown in FIG. 8 except for the following points.

That is, in this embodiment, a semiconductor chip contacting member 144 is provided independently of the bonding unit 120. The semiconductor chip contacting member 144 has a through opening 148 having a square cross section through which the bonding tool 126 extends. The ultrasonic wave oscillating element 128 is provided to vibrate the semiconductor chip contacting member 144. The through opening 148 has a stepwise structure so that the opening expands downward. A tapered surface 148a is formed at the end of the opening 148 facing the wiring board 112 so that the semiconductor chip 116 contacts the tapered surface 148a when the semiconductor chip contacting member is urged toward the semiconductor chip 116.

In the above-mentioned structure, the semiconductor chip 116 is pressed by the bonding tool 126, and the semiconductor chip contacting member 144 transmits the ultrasonic vibration to the semiconductor chip 116 independently of the bonding tool 126. Accordingly, the semiconductor chip is securely held by the semiconductor chip contacting member 144, which positively transmits the ultrasonic vibration from the ultrasonic wave oscillating element 128 to the semiconductor chip 116. Additionally, a desired pressing force can be exerted on the semiconductor chip 116 solely by the bonding tool 126, which prevents the semiconductor chip 116 from being damaged due to the pressing force.

Additionally, since the semiconductor chip 116 is brought into contact with the tapered surface 148a, the semiconductor chip 116 can be easily positioned within the through opening, and the same bonding unit can be commonly used for semiconductor chips having different sizes.

The sensor 146 includes, similar to the third embodiment, the piezoelectric element 140, which is fixed to the semiconductor chip contacting member 144, so as to measure a change in a current generated by the piezoelectric element 140. As mentioned above, since the semiconductor chip 116 is securely held by the semiconductor chip contacting member 144, the semiconductor chip 116 can vibrate together with the semiconductor chip contacting member 44 without slippage. Accordingly, the sensor 146 according to the present embodiment can detect and monitor the waveform of an actual vibration transmitted to the semiconductor chip 116.

According to the ultrasonic bonding method performed by the flip chip bonding apparatus 142 shown in FIG. 10, the waveform of an actual vibration of the wiring board 112 is detected and monitored by the sensor 146, and the condition of bonding is controlled as in the same manner as the above-mentioned embodiments.

A description will now be given of an ultrasonic bonding method and apparatus according to a fifth embodiment of the present invention.

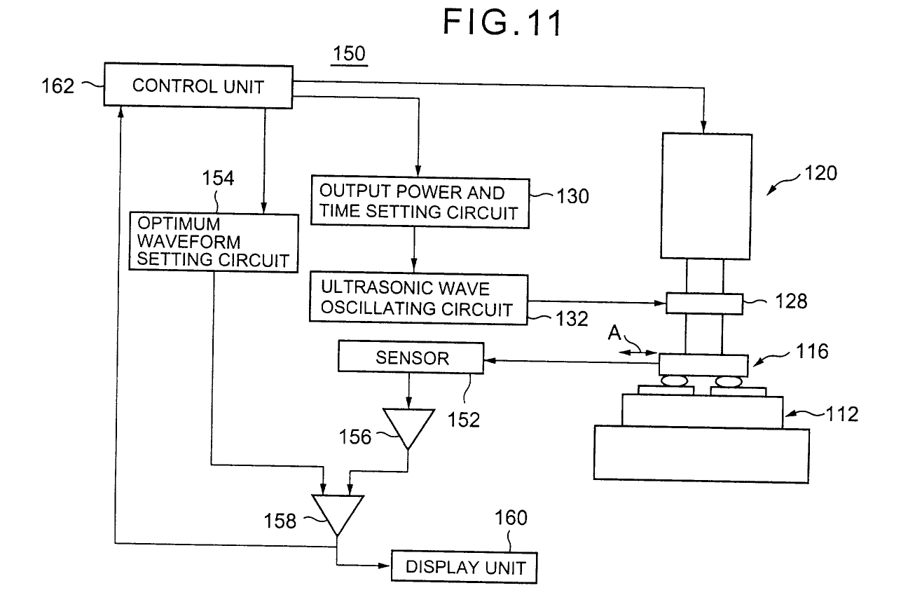

FIG. 11 is an illustration of a structure of a flip chip bonding apparatus 150 according to the fifth embodiment of the present invention. In FIG. 11, parts that are the same as the parts shown in FIG. 8 are given the same reference numerals, and descriptions thereof will be omitted.

The flip chip bonding apparatus 150 according to the present embodiment has the same structure as the flip chip bonding apparatus 110 shown in FIG. 8 except that the structure of the ultrasonic wave oscillating mechanism is different from that of the second embodiment.

Specifically, the ultrasonic oscillating mechanism of the present embodiment includes an optimum waveform setting circuit 154, an A/D converter 156, a comparator circuit 158 and a display unit 60 in addition to the ultrasonic wave oscillating element 128, the output power and time setting circuit 130 and the ultrasonic wave oscillating circuit 132 provided in the flip chip bonding apparatus 110 according to the second embodiment of the present invention. The optimum waveform setting circuit 154 sets an optimum waveform with respect to the ultrasonic vibration to be generated by the ultrasonic wave oscillating element 128 based on accumulated data of various waveforms generated in various bonding conditions. The optimum waveform output from the optimum waveform setting circuit is supplied to the comparator circuit 158. The operations of the bonding unit 120 and the operation of the ultrasonic wave oscillating mechanism are controlled by a control unit 162. The control unit 162 also controls a handling operation of the wiring bard 112 and a handling operation of the semiconductor device produced by the flip chip bonding apparatus 150.

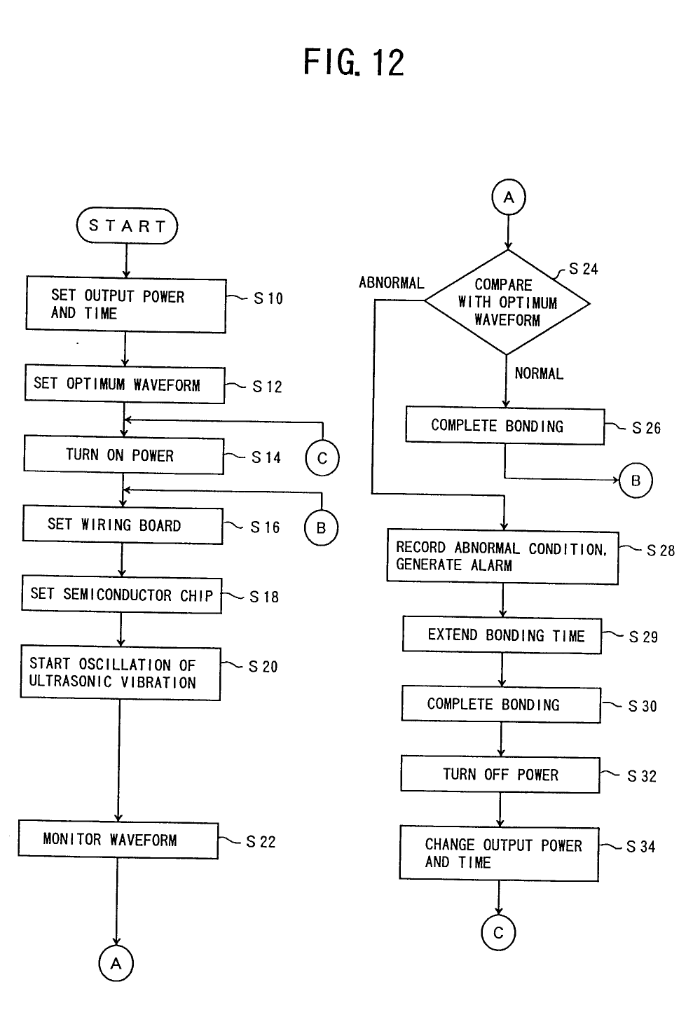

A description will now be given, with reference to FIG. 12, of an ultrasonic bonding method performed by the flip chip bonding apparatus 150 shown in FIG. 11. FIG. 12 is a flowchart of the ultrasonic bonding operation performed by the flip chip bonding apparatus 150 shown in FIG. 11.

When the ultrasonic bonding operation is started, a predetermined output power and duration of an ultrasonic wave to be generated is supplied, in step S10, to the output power and time setting circuit 130 by using an input device (not shown in the figure) so as to set the output power and the duration of the ultrasonic wave to be generated by the ultrasonic wave oscillating element 128. Additionally, in step S12, an optimum waveform is supplied to the optimum waveform setting circuit 154 by the input device. Thereafter, in step S14, the control unit 162 is turned on so as start a bonding operation.

In step S16, the wiring board 112 is placed on the stage 114 by the automatic conveyor device (not shown in the figure). Then, in step S18, the semiconductor chip 116 is picked up by suctioning by the bonding tool 126 and is placed on the wiring board 112 so that the bumps 118 of the semiconductor chip 116 contact the respective electrode pads 111 of the wiring board 112. The bonding tool 126 is further moved downward so that a predetermined pressing force is applied to the semiconductor chip 116.

Thereafter, in step S20, the ultrasonic wave oscillating circuit 132 is operated based on the output power and time setting circuit 130 so as to generate the ultrasonic vibration by the ultrasonic oscillating element 128. The ultrasonic vibration generated by the ultrasonic oscillating element 128 is transmitted to the semiconductor chip 116, and thereby, the semiconductor chip 116 vibrates in the direction indicated by the arrow A in the figure. Thus, the bumps 118 of the semiconductor chip 116 and the electrode pads 111 of the wiring board 112 are bonded to each other by the ultrasonic vibration.

When a predetermined time period has passed after the generation of the ultrasonic vibration was started, the waveform of the vibration of the semiconductor chip 116 is detected and monitored in step S22. The waveform, which is an analog signal, detected by the sensor 152 is supplied to the A/D converter circuit 156 so as to be converted into a digital signal, and a digital waveform signal is output from the A/D converter 156. The digital waveform signal is supplied to the comparator circuit 158.

The comparator circuit 158 compares, in step S24, the digital waveform signal supplied by the A/D converter circuit 156 with the optimum waveform signal supplied by the optimum waveform setting circuit 154, and outputs the result of the comparison. The output of the comparator circuit 158 is supplied to the display unit 160 so as to display the actual waveform of the vibration of the semiconductor chip 116 and the optimum waveform to be achieved. If the difference between the digital waveform signal supplied by the A/D converter circuit 156 and the digital optimum waveform signal supplied by the optimum waveform setting circuit 154 is within a predetermined allowable range, it is determined that the bonding operation is normal and the routine proceeds to step S26. On the other hand, if the difference between the digital waveform signal supplied by the A/D converter circuit 156 and the digital optimum waveform signal supplied by the optimum waveform setting circuit 154 is out of the predetermined allowable range, it is determined that the bonding operation is abnormal and the routine proceeds to step S28.

In step S26, the bonding operation is continued for the predetermine time period set by the output power and time setting circuit 130, and the semiconductor device is removed from the flip chip bonding apparatus 150. Thereafter, the routine returns to step S16 so as to perform anther bonding operation.

On the other hand, if it is determined that the bonding operation is abnormal, the abnormal condition is recorded and an alarm is generated, the time period for application of the ultrasonic vibration which has been set by the output power and time setting circuit 130 is changed, in step S29, to a second predetermined time period such as twice the originally set time period. Thereafter, when the second predetermined time period has passed, it is determined, in step S30, that the bonding operation is completed, and the semiconductor device is removed from the flip chip bonding apparatus 150 and is conveyed to a test yard for evaluation.

Then, in step S32, the bonding unit 120 is turned off. Thereafter, in step S34, the abnormal condition recorded in step S28 is analyzed, and the output power and time set by the output power and time setting circuit 130 are changed to appropriate values. Then, the routine returns to step S14 so as to perform another bonding operation.

It should be noted that all of the above-mentioned steps shown in FIG. 12 are not always be performed. That is, for example, after the alarm is generated in step S28, the abnormal semiconductor device may be removed from the flip chip bonding apparatus 150 without changing the time period for the bonding operation. Additionally, step S34 may be eliminated after the bonding unit 120 is turned off. That is, a cause of the abnormality may be eliminating by investigating the apparatus, and another bonding operation may be started after eliminating the cause of the abnormality.

According to the ultrasonic bonding method performed in the flip chip bonding apparatus 150 according to the present embodiment, the waveform of the vibration of the semiconductor device 116 is detected and monitored by the sensor 152, and the detected waveform is compared with the optimum waveform so as to determine whether the bonding operation is normal or abnormal. Additionally, by displaying both the waveform of the actual vibration and the optimum vibration on the display unit 160, an accurate determination can be made as to whether the bonding operation is normal or abnormal. Further, if an abnormality occurs in the bonding operation, an alarm is generated, and the apparatus is temporarily stropped so as to prevent continuous generation of the abnormality. Additionally, the abnormal condition is analyzed prior to the subsequent bonding operation so as to change the output power and the time period of the ultrasonic vibration so that a high quality control can be achieved.

A description will now be given of an ultrasonic bonding method and apparatus according to a sixth embodiment of the present invention.

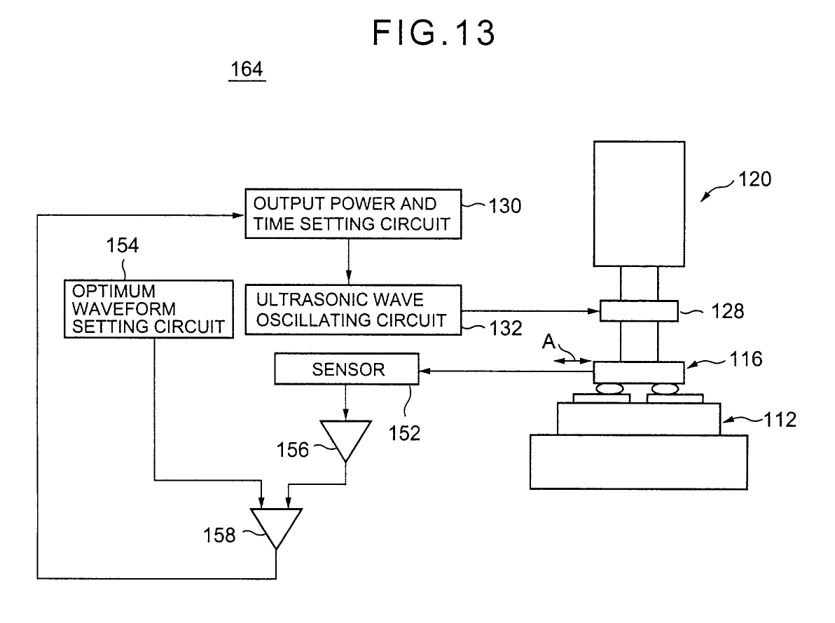

FIG. 13 is an illustration of a structure of a flip chip bonding apparatus 164 according to the sixth embodiment of the present invention. In FIG. 13, parts that are the same as the parts shown in FIG. 8 are given the same reference numerals, and descriptions thereof will be omitted.

The flip chip bonding apparatus 164 according to the present embodiment has the same structure as the flip chip bonding apparatus 150 shown in FIG. 11 except for the following points.

That is, the monitoring of the waveform of the vibration of the semiconductor chip 116 is performed at a predetermined time interval 8sampling interval) after the bonding operation is started. Then, the differential signal output from the comparator circuit 158 is supplied to the output power and time setting circuit 130 at a time. Thereby, the output power and the time period for generation of the ultrasonic vibration is changed by a predetermined amount previously set in accordance with the differential signal, and a feedback control is achieved in the bonding operation. It should be noted that, similar to the fifth embodiment, the optimum waveform to be compared with in the present embodiment is the waveform of the ultrasonic vibration when the bonding operation is in a good condition and immediately before the bonding operation is completed.

Additionally, the display device 160 shown in FIG. 11 may be provided to the flip chip bonding apparatus 164. Additionally, similar to the fifth embodiment, a signal line may be provided so as to supply a signal from the comparator circuit 158 to the control unit 162.

According to the ultrasonic bonding method performed in the flip chip bonding apparatus 164 according to the present embodiment, since the feed back control is performed in the bonding operation, the semiconductor device is prevented from being defective due to an improper or incomplete bonding operation. Additionally, if the waveform of the actual vibration differs from the optimum waveform when the time period for generation of the ultrasonic vibration is changed to several times the originally set time period, it is considered that an abnormality other than that relates to the ultrasonic bonding operation occurs in the flip chip bonding apparatus. In such a case, it is not preferable to continue the bonding operation by increasing the bonding time, and, therefore, the bonding operation may be stopped when, for example, a time period equal to three times the originally set time period has passed. If the cause of the abnormality does not relate to the semiconductor device but relates to the bonding apparatus, the abnormality may continuously occur in the subsequent bonding operations. Thus, in such a case, it is preferable that the operation of the entire bonding apparatus be stopped without proceeding to the next bonding operation.

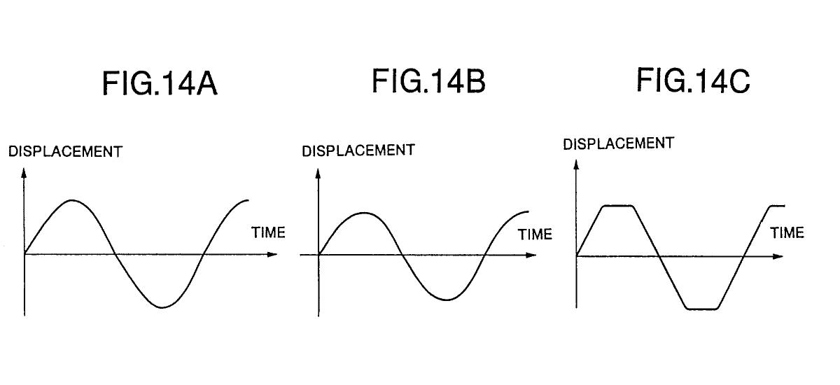

A discussion will be made, with reference to FIGS. 14A through 14C, of a waveform of the ultrasonic vibration.

In the initial stage of the bonding operation, bonding is not performed, and the semiconductor chip integrally vibrates with the ultrasonic wave oscillating element. Thereby, the waveform of the semiconductor chip is identical to the waveform of the ultrasonic wave oscillating element. Thus, in the initial stage of the bonding operation, a sine waveform shown in FIG. 14A is obtained from the semiconductor chip.

As the bonding operation progresses, the bumps of the semiconductor chip are partially bonded to the electrode pads of the wiring board. In such a state, a bonded portion is partially broken at a time when the amplitude of the ultrasonic vibration is maximum, that is, when the movement of the semiconductor chip in the horizontal direction is folded. Thereby, a delay is generated in the vibration of the semiconductor chip, which results in the waveform of the vibration of the semiconductor chip approaches to a triangular waveform as shown in FIG. 14B. Then, in the final stage of the bonding operation, that is, immediately before the completion of the bonding operation, the waveform of the vibration of the semiconductor chip becomes approximately a triangular waveform as shown in FIG. 14C.

The triangular waveform show in FIG. 14C corresponds to the optimum waveform which is set by the optimum waveform setting circuit provided in the above-mentioned embodiments.

A consideration will now be made of the waveform when an abnormality occurs in the bonding operation.

It is considered that one of the causes of an incomplete bonding is an occurrence of slippage between the bonding tool and the semiconductor chip. If a foreign material exists between the bonding tool and the semiconductor chip, the magnitude of the slippage is increased, which results in the ultrasonic vibration not being sufficiently transmitted to the bumps. Such a phenomenon may occur when the connection between the semiconductor chip and the ultrasonic wave oscillating element is loose.

If the above-mentioned phenomenon occurs, the amplitude of the waveform of the vibration of the semiconductor chip becomes smaller than that of the optimum waveform. In the utmost case, the amplitude of the vibration of the semiconductor chip may be closed to zero.

However, in the above-mentioned embodiments, the waveform of the vibration of the semiconductor chip or the wiring board is monitored so as to compare the waveform of an actual vibration with the optimum waveform so that the state of bonding whether the bonding is normal or abnormal can be determined based on the result of the comparison.

The present invention is not limited to the specifically disclosed embodiments, and variations and modifications may be made without departing from the scope of the present invention.

The present application is based on Japanese priority applications No. 11-189282 filed on Jul. 2, 1999 and No. 11-303062 filed on Oct. 25, 1999.

What is claimed is:

1. A head assembly of a disk apparatus, comprising:
a head IC chip having a plurality of protruding electrodes made of gold; and
a suspension supporting the head IC chip, the suspension having a plurality of electrode pads connected to the respective protruding electrodes of the head IC chip, each of the electrode pads having a surface layer made of gold,
wherein the protruding electrodes of the head IC chip are bonded to the electrode pads of the suspension by ultrasonic bonding.

2. The head assembly as claimed in claim 1, further comprising a reinforcing member filled in a space between the head IC chip and the suspension.

3. A disk apparatus comprising:
a disk for storing information;
an arm movable relative to the disk;
an actuator driving the arm; and
a head assembly mounted to the arm, the head assembly comprising:
a head IC chip having a plurality of protruding electrodes made of gold; and
a suspension supporting the head IC chip, the suspension having a plurality of electrode pads connected to the respective protruding electrodes of the head IC chip, each of the electrode pads having a surface layer made of gold,
wherein the protruding electrodes of the head IC chip are bonded to the electrode pads of the suspension by ultrasonic bonding.

4. An ultrasonic bonding method for bonding a semiconductor chip having a plurality of protruding electrodes to a wiring board having a plurality of electrode pads, the ultrasonic bonding method comprising the steps of:
bonding the protruding electrodes of the semiconductor chip to the electrode pads of the wiring board by applying an ultrasonic vibration to one of the semiconductor chip and the wiring board;
detecting an actual waveform of the ultrasonic vibration of the one of the semiconductor chip and the wiring board; and
controlling the bonding process based on the actual waveform of the ultrasonic vibration of the one of the semiconductor chip and the wiring board.

5. The ultrasonic bonding method as claimed in claim 4, wherein the step of controlling includes the steps of:
setting an optimum waveform with respect to the ultrasonic vibration of the one of the semiconductor chip and the wiring board; and
comparing the actual waveform with the optimum waveform so as to obtain a difference between the actual waveform and the optimum wave form so that the bonding process is controlled based on the difference.

6. The ultrasonic bonding method as claimed in claim 5, further comprising the step of displaying the actual waveform and the optimum waveform on a display unit.

7. The ultrasonic bonding method as claimed in claim 6, further comprising the step of alarming when the difference between the actual waveform and the optimum waveform exceeds a predetermined allowable range.

8. The ultrasonic bonding method as claimed in claim 7, further comprising the step of stopping the bonding process when the difference between the actual waveform and the optimum waveform exceeds a predetermined allowable range.

9. The ultrasonic bonding method as claimed in claim 5, wherein the bonding process is controlled according to a feedback control based on a result of comparison between the actual waveform and the optimum waveform.

10. An ultrasonic bonding apparatus for bonding a semiconductor chip having a plurality of protruding electrodes to a wiring board having a plurality of electrode pads, the ultrasonic bonding apparatus comprising:
an ultrasonic vibration generating mechanism generating an ultrasonic vibration by an ultrasonic wave oscillating element, the ultrasonic vibration being transmitted to one of the semiconductor chip and the wiring board so as to bond the protruding electrodes of the semiconductor chip to the electrode pads of the wiring board; and
a sensor detecting an actual waveform of the ultrasonic vibration of the one of the semiconductor chip and the wiring board so as to control the ultrasonic vibration generated by the ultrasonic vibration generating mechanism based on the actual waveform detected by the sensor.

11. The ultrasonic bonding apparatus as claimed in claim 10, wherein the ultrasonic vibration generating mechanism comprises:
an ultrasonic wave oscillating circuit which drives the ultrasonic wave oscillating element; and
an output power and time setting circuit for setting an output power of the ultrasonic wave oscillating element and setting a time period for generating the ultrasonic vibration.

12. The ultrasonic bonding apparatus as claimed in claim 11, wherein the ultrasonic vibration generating mechanism further comprising:
an optimum waveform setting circuit which sets an optimum waveform of the ultrasonic vibration of the one of the semiconductor chip and the wiring board; and
a comparator comparing the actual waveform detected by the sensor with the optimum waveform so as to obtain a difference between the actual waveform and the optimum waveform.

13. The ultrasonic bonding apparatus as claimed in claim 12, further comprising a display unit which displays a result of comparison of the comparator.

14. The ultrasonic bonding apparatus as claimed in claim 12, further comprising means for alarming when the difference between the actual waveform and the optimum waveform exceeds a predetermined allowable range.

15. The ultrasonic bonding apparatus as claimed in claim 12, further comprising a control unit which controls start and stop of an operation of the ultrasonic bonding apparatus, wherein the control unit stops the operation of the ultrasonic bonding apparatus when the difference between the actual waveform and the optimum waveform exceeds a predetermined allowable range.

16. The ultrasonic bonding apparatus as claimed in claim 12, wherein a result of comparison of the comparator is supplied to the output power and time setting circuit so as to control the actual waveform according to a feedback control.
